(19) United States
(12) Patent Application Publication
(10) Pub. No.: US 2017/0075944 A1
(43) Pub. Date: Mar. 16, 2017

(54) Systems and Methods For Socializing Machines Using Autonomous Software Agents

(71) Applicant: Stephen E. Overman, Renton, WA (US)

(72) Inventor: Stephen E. Overman, Renton, WA (US)

(21) Appl. No.: 14/852,389

(22) Filed: Sep. 11, 2015

(51) Int. Cl. G06F 17/30; G06F 21/62

(52) U.S. Cl. CPC G06F 17/30371; G06F 21/6245; G06F 17/30303

(57) ABSTRACT

A platform for socializing devices includes a knowledge database, a rules database, an event processor, an event queue, an advocate message processor, and an advocate message queue. A plurality of software advocates, each corresponding to a respective one of the devices, resides on the advocate message processor. The knowledge database includes a plurality of private social graphs, each corresponding to a respective one of the advocates. A policy database includes rules governing the relationships between and among the advocates and devices. The event processor is configured to process incoming payloads based on the knowledge database and the policy database.

### TECHNICAL FIELD

The present invention relates, generally, to the socialization of devices within the internet of things (IoT) and, more particularly, to the use of autonomous software agents to implement socialization among machines.

### BACKGROUND

Social networking platforms such as Facebook™, Twitter™, Instagram™, and Flickr™ have forever changed the way people communicate, collaborate, and otherwise interact. Going forward, however, the majority of internet connections will not be among humans, but among devices. Indeed, experts anticipate 30 to 50 billion connected devices by 2020. Harnessing the data associated with the relationships among these devices, and their human owners, is one of the objectives of the present invention.

Presently known tools for extending the dynamics of social networking to networks of objects include Paraimpu™ and ThingSpeak™, available at www.paraimpu.com and www.thingspeak.com, respectively. In particular, the Paraimpu tool facilitates inter-connecting machines, devices, and sensors, and linking them to existing social networks. ThingSpeak is an open source IoT application and API for storing and retrieving data from devices (also referred to herein as things) using the HTTP protocol over the Internet. Both approaches purport to enable a social network of things. However, implementing socialization at the machine level by embedding the social architecture into the machines themselves is incredibly complex and cumbersome, particularly in the multifaceted context of the IoT.

An architecture in thus needed which facilitates the apparent socialization of devices without embedding the social architecture into the device itself.

### SUMMARY OF THE INVENTION

Various embodiments of the present invention employ autonomous software agents—referred to herein as advocates—to enable machines to appear social. The advocates operate in a virtual social network ecosystem, and utilize real time and historical cognitive intelligence maintained in social graphs. Consequently, manufacturers do not need to embed the code comprising the social architecture into the devices. Rather, only the universal resource identifiers (URI) and application programming interface (API) keys are required in order for the devices to leverage—through their advocates—the social network of machines of the present invention.

Other embodiments allow humans to impose rules to protect their privacy while their advocates interact with other advocates. In this way, humans can gradually build trust in the ecosystem as their stated preferences are respected by the machines.

Other embodiments socialize machines by leveraging the vast API ecosystem currently growing within the internet, and particularly the IoT. Those skilled in the art will appreciate that, in an embodiment, the machines only appear to socialize with each other, when in reality one device's advocate “talks” to another device's advocate to thereby give the appearance to the consumer that the devices themselves are social.

In other embodiments, each advocate has its own private social graph, communicates with other private social graphs via predetermined permissions defined by the human owner of the advocate, and leverages the entire incremental change history of relationships to leverage enterprise networked intelligence.

Various features of the invention are applicable to, inter alia, a network of Internet-of-Things devices and sensors; heterogeneous computing environments; and integrated environments including human and machine social networks.

### BRIEF DESCRIPTION OF THE DRAWINGS

The present invention will hereinafter be described in conjunction with the appended drawing figures, wherein like numerals denote like elements, and:

FIG. 1 is an architectural block diagram of a cloud based platform for social automation through networked intelligence in accordance with various embodiments;

FIG. 2 is a schematic diagram of a knowledge database showing a series of individual social graphs separated by secure partitions in accordance with various embodiments;

FIG. 3 is a schematic diagram of an individual private social graph in accordance with various embodiments;

FIG. 4 is schematic representation of a data element in accordance with various embodiments;

FIG. 5 is a schematic architectural diagram depicting the manner in which advocates interact to facilitate the socialization of machines in accordance with various embodiments;

FIG. 6 is a logical schematic flow diagram depicting the implementation of a perspective computing platform in accordance with various embodiments;

FIG. 7 is a schematic view of an exemplary graphical user interface (GUI) for a client application running on a hand-held device in accordance with various embodiments; and

FIG. 8 is a process flow diagram for instantiating, onboarding, and otherwise managing an advocate in accordance with various embodiments.

### DETAILED DESCRIPTION

Various embodiments relate to socializing devices using networked intelligence and human defined policies in the context of the Internet-of-Things.

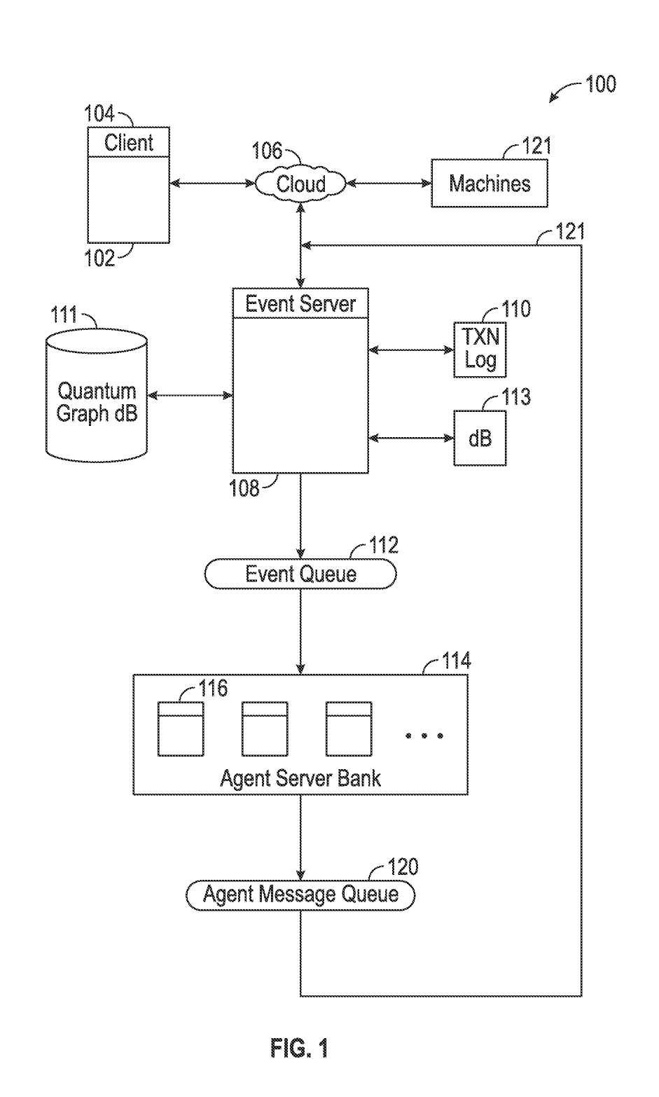

Referring now to FIG. 1, an improved social platform 100 includes a device 102 configured to run a client application 104, a network 106, an event server 108 configured to pull information from a knowledge database 111 (also referred to herein as a QuantumGraph™ database) and a rules database 113, a transaction log 110, an asynchronous event queue 112, a server cluster 114 comprising a plurality of agent servers 116, and an asynchronous agent message queue 120. Conceptually, processing an event query through the system 100 is generally analogous to sending a Tweet over the Twittersphere, as discussed in greater detail below.

The device 102 may comprise any suitable hand-held, portable, desk top, or other computing device such as a mobile or cellular telephone, smartphone, tablet, notebook, lap-top, IPad, Nook, netbook, ultra-mobile pocket PC (UMPC), or personal digital assistant (PDA). The client application 104 may be any suitable client side application configured to communicate with the event server such as, for example, the ETHoS™ platform available from Standpoint™ Software (www.standpointsoftware.com).

The network 106 may be any suitable wide area network, local area network, wireless local area network, cluster area network, metropolitan area network, storage area network, system area network, server area network, campus area network, controller area network, personal area network, proprietary network, or any voice, telephone, and/or data network including the internet. In the context of the present invention, the term cloud-based network or service contemplates but does not require implementation in a software-as-a-service (SaaS) environment.

The core implementing architecture is sometimes referred to herein as the advocate (or agent) ecosystem, and generally comprises the event server 108, the event queue 112, the agent server bank 114, and the agent message queue 120. In one embodiment, the event server 108 includes sub-classed event processors, which parse incoming fact-based event messages while collecting policies from the rules database 113 and facts from the QuantumGraph database 111. The resulting networked intelligence is used to structure and transmit appropriate event messages to the advocates.

As described in greater detail below, each advocate comprises an autonomous software machine or process which resides on an agent server. Conceptually, advocates exchange information obtained from the QuantumGraph database 111 in accordance with rules applied from the rules database 113. More precisely, the advocates do so by circulating and iteratively processing messages back through the system via message path 121 using a suitable conversational multi-agent language such as FIPA (foundation for intelligent physical agents) using W3C messaging and advanced encryption standard (AES) 128-bit encryption protocols.

The QuantumGraph database 111 comprises a plurality of respective private social graphs, which together constitute a networked intelligence store, also referred to herein as a composite graph or world social graph. Significantly, the relationships between facts and, more particularly, the incremental changes in these relationships over time, are stored in the QuantumGraph database for all participating advocates, humans, and devices. The application of big data analytics to the data store allows the present system to harvest heretofore unprecedented information and trends from otherwise mundane interactions among humans and their devices.

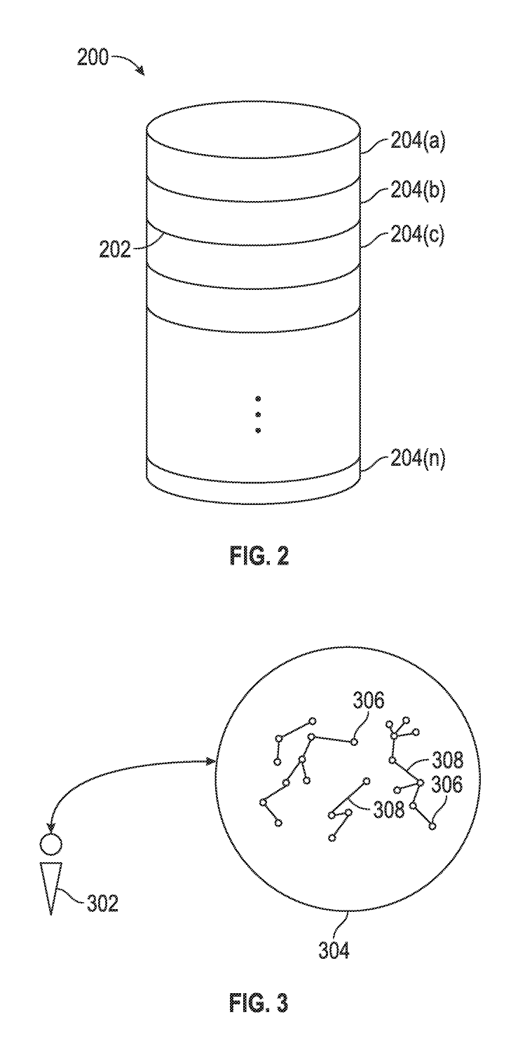

Referring now to FIG. 2, an exemplary QuantumGraph database 200 comprises a series of individual social graphs 204(i)-204(n) separated by a secure partition 202, with each social graph uniquely corresponding to a respective advocate. That is, in a preferred embodiment, there is a one to one relationship between an advocate and its human owner. Alternatively, a particular human may own several advocates, as desired. The universe of private social graphs, including a complete history of incremental changes to the relationships stored therein, make up the aggregate QuantumGraph database 200. As described in greater detail below, the application of policies from the rules database 113, allow the advocates to securely exchange information and otherwise “socialize” in accordance with their human-defined permissions. Moreover, although it is intuitively instructive to view the QuantumGraph base 200 as facilitating the exchange of information among advocates, in an embodiment the mechanism by which information is shared, exchanged, and disambiguated typically involves the processing of sequential messages through the event server pipeline, as discussed below.

Referring now to FIG. 3, each individual social graph 204 of FIG. 2 corresponds to a private social graph 304 comprising a plurality of facts, each represented by an edge 306 connecting two vertices 308. In an embodiment, each private social graph bears a 1:1 relationship with a socially intelligent software agent (advocate) 302. Each vertex 308 may comprise a single advocate, human, machine (device), or logical object, and each edge 306 represents the relationship between the vertices, as discussed further below.

Referring again to FIG. 1, the rules database 113 comprises the aggregate preferences, rules, and policies governing the relationships among advocates, humans, and devices. Policies define the relationship between an advocate and a thing, between advocates, and between an advocate and a person.

In an embodiment, each human user, on behalf of their advocate, populates the database 113 with that human's polices, for example, using a device 102 (FIG. 1). As described in greater detail below, policies may be defined for an individual, or a group of individuals sharing one or more common attributes such as employees. The rules database may be implemented using any suitable format. In a preferred embodiment, the rules database comprises a configuration file of sequential and/or nested “If This Then That” (IFTTT) statements, where the “that” portion of a statement may be either a conditional action which depends on the outcome of one or more additional IFTTT statements, or an atomic obligation which must be completed before other IFTTT statements are processed.

The QuantumGraph database comprising the universe of private social graphs may be implemented in any convenient manner. In a preferred embodiment, a Representational State Transfer (REST or RESTful) interface communicates over the Hypertext Transfer Protocol using HTTP verbs (GET, POST, PUT, DELETE) to send and receive data. The data is suitably maintained in a triple store or Resource Description Framework (RDF) format, and retrieved through semantic queries. Thus, the entire database may comprise a set of “subject-predicate-object” triples. SPARQL is a semantic query language suitable for retrieving and manipulating data stored in an RDF format such as a triple store.

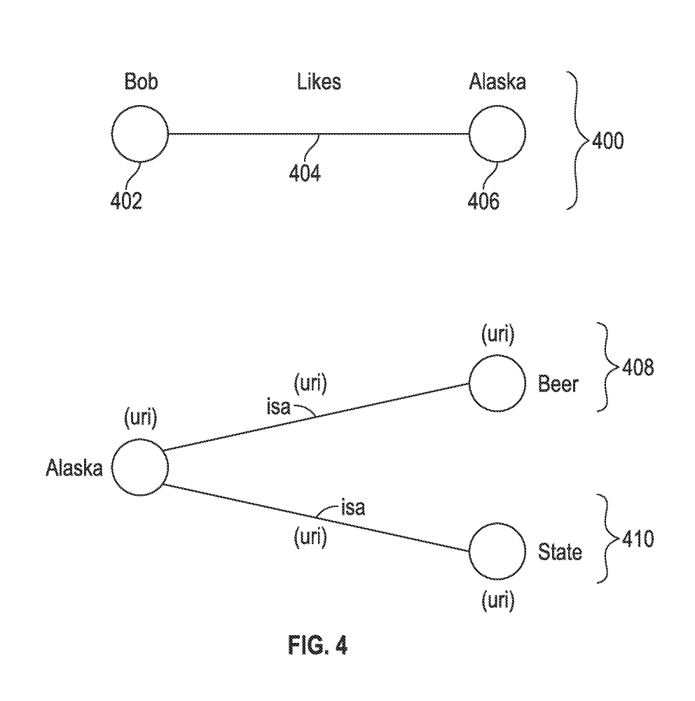

With reference to FIG. 4, an exemplary fact 400 within the data store comprises a subject 402 (Bob), a predicate 404 (Likes), and an object 406 (Alaska), representing the data element “Bob Likes Alaska”. In accordance with RESTful architecture protocols, each vertex (e.g., thing, device, machine, advocate, human, or logical object) and each edge (the relationship between the vertices) is defined by a unique URI address within the database. Using these URIs, advocates can exchange information with other advocates. Moreover, by using iterative artificial intelligence (AI) techniques, the system allows advocates to resolve ambiguities, where appropriate.

For example and with continued reference to FIG. 4, the data element (fact) “Bob Likes Alaska” may require clarification, inasmuch as Alaska can be a brand of beer in one context (fact 408), and a sovereign state in a different context (fact 410). In order to disambiguate the latent ambiguity, those skilled in the art will appreciate that the system may employ natural language and other inferential and/or machine learning techniques. That is, semantic attributes may be employed to imbue the facts with information and thereby provide cognitive intelligence to the advocates thru inference. Storing the intelligence associated with relationships thru time provides economically powerful data for harvesting via big data analytics.

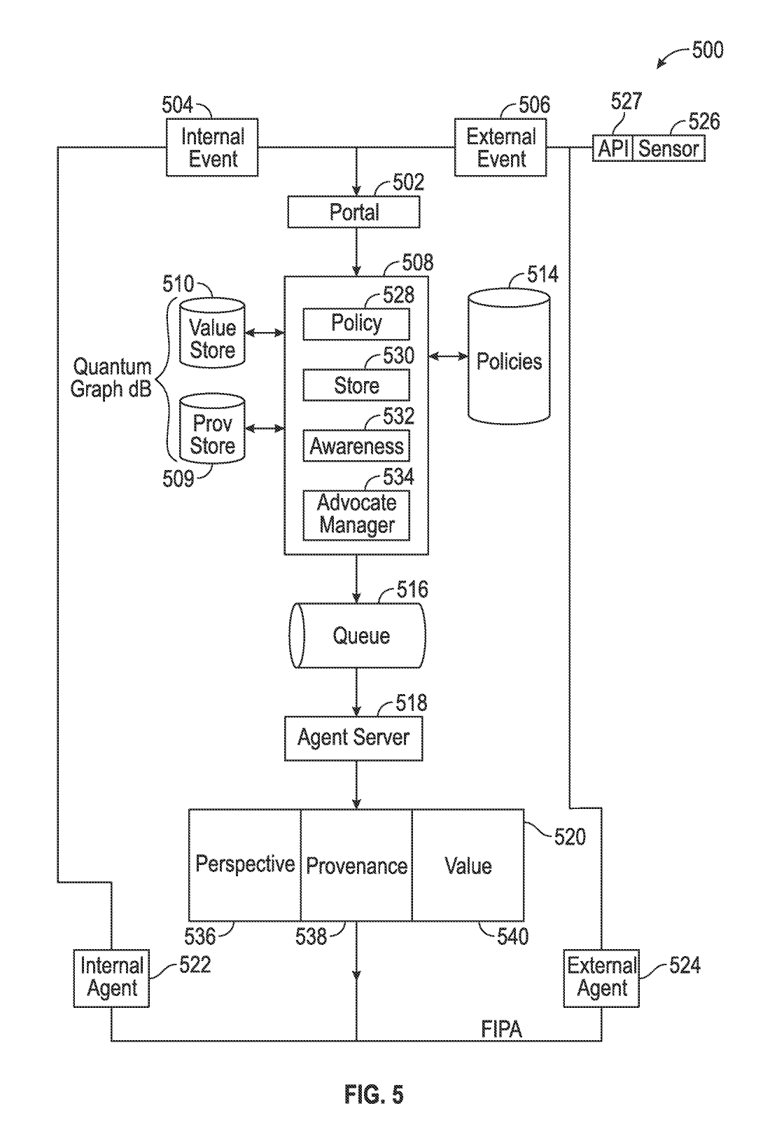

Referring now to FIG. 5, the manner in which advocates interact to facilitate the socialization of machines will now be described in the context of an exemplary use case. More particularly, a networked intelligence and social automation platform 500 includes an event portal 502, an event processor 508, a fact database 509, a policy database 514, an event queue 516, an agent (advocate) server 518, and an agent message queue 520. Internal events 504 (typically involving an advocate-to-advocate relationship) and external events 506 (typically involving an advocate-to-device or advocate-to-person relationship) enter the system through the event portal 502, which may be a web based service. The fact database 509 comprises a value store 510 wherein values (or changes in values) of attributes (e.g., x=8; Alaska=beer) may be persisted, and a provenance store 512 wherein facts (or incremental changes thereto) may be stored. This allows for the forensic review of every state of every relationship and fact within the historical record maintained within the knowledge database.

The event processor 508 includes a policy processing module 528, a payload processing module 530, an awareness processing module 532, and an agent management processing module 5534. The agent message queue 520 includes a perspective processing module for processing meta data, a provenance processing module 538, and a value processing module 540. Messages output by the agent message queue 520 may be “directed” to an internal agent 522, an external agent 524, or both. The external messages 506 may emanate from the external agent 524 or, alternatively, from an external device such as, for example, a sensor 526 having an associated API 527.

An exemplary use case illustrating various aspects of the present invention involves an employee uploading a photograph to a public website while at work. More particularly, a client application (e.g., ETHoS) running on the employee's smartphone detects the taking of the photograph, and sends an external event 506 to the portal 502. That is, the client application running on the employee's device functions as the listening sensor for the employee's advocate, using the API on the natural application (camera) coupled with the employer's IT policy which requires the employee to allow the ETHoS application to listen for events such as the taking and uploading of photos. Moreover, the device has an existing relationship with the client application as a result of being installed on the device, and this relationship is stored in the employee's advocate's social cognitive graph.

Upon receiving the event, the portal 502 feeds the event to the event processor 508. The event may include an ID header and a payload, which may also include any number of attributes. The ID header preferably identifies the sending party's URI, and the payload includes one or more facts or attributes. The event processor reads the payload information, and uses the ID header to formulate a SPARQL query into the triple store fact database 509. The event processor also looks up the policies in the database 514 that govern the relevant relationships. In the present example, neither the employee's nor the employer's policies require any action to be taken simply because a photograph has been taken on the employer's premises. However, as explained below, uploading the photograph may constitute a potential security breach requiring a predetermined response, provided other conditions are met. One such condition involves whether the photograph was taken within the boundaries of the company's virtual geo-fence, as determined by a GPS sensor operating on the employee's smartphone and also deep linked to the client application in accordance with the employer's policies.

The client application running on the employee's device (smartphone) listens for the photo upload, enabled by the employer's IT policy which also allows client application to deep link with the third party application (e.g., Instagram), to detect uploading of the photograph. The event message associated with uploading the picture to Instagram while the employee is located within the employer's geo-fence invokes the employer's policies requiring that a message be sent to the employee's supervisor advising that a security breach may have occurred.

In the foregoing example, each of the three events (entering the virtual geo-fence, taking the photograph, and uploading the photograph) are “facts” sent from the employee's smartphone into the advocate ecosystem by the client application and stored/updated in the fact database 509. These facts are processed by the event processor, and the relevant policies are pulled and analyzed against the facts. The system also accesses the employee's advocate's private cognitive social graph within the provenance store 512 to evaluate any relationships invoked by the events. The policies are then evaluated based on intelligence gleaned from the social store.

In the present case, the policies require that the employee's supervisor be notified. Consequently, the event server 508 sends a message to the message queue 516, which broadcasts the message to the advocate society which resides within the agent server 518. The employee's supervisor as well as the employer's IT officer (specifically, their respective advocates) pick up the message as a result of analogous processing within the agent server processor 520, and send another event message back thru the foregoing pipeline, whereupon the messages are processed against the QuantumGraph database 509 and the policy store 514. Based on the employer's policies and the supervisor's and IT officer's social graphs, alert messages are sent to the respective destinations defined by their ETHoS preferences (e.g., apple alert, email, text, or ETHoS dashboard).

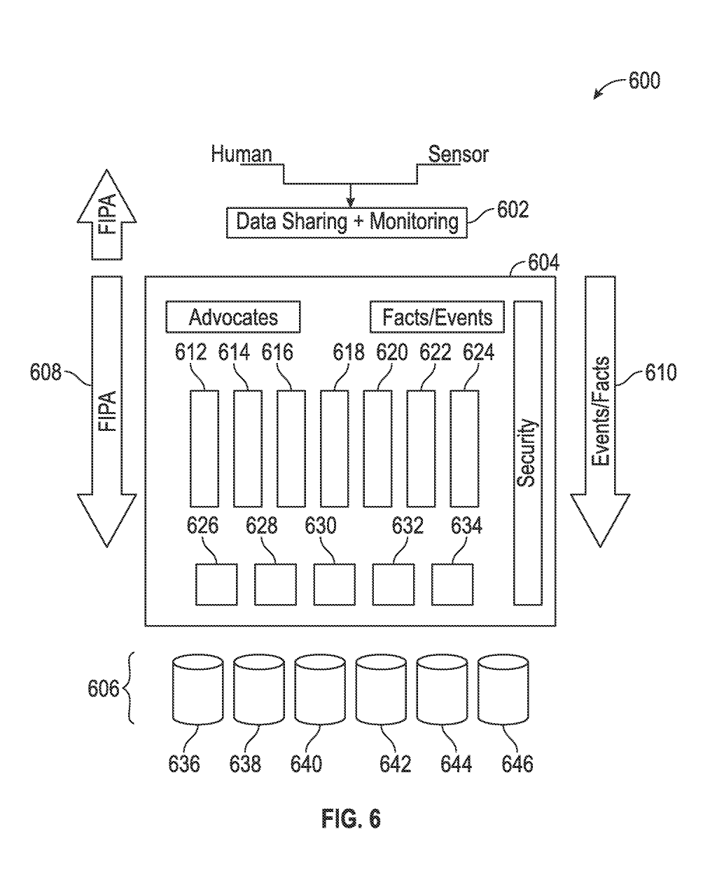

Referring now to FIG. 6, an important aspect of the present system surrounds the ability to unravel, disambiguate, and resolve conflicts, nuances, semantic discrepancies, and ambiguities associated with events and facts to thereby impart cognitive networked intelligence (“multi-perspective”) to the advocates. More particularly, a process flow diagram 600 includes a data sharing and monitoring application module 602 (e.g., the ETHoS client application) through which human triggered and sensor triggered events pass, a perspective computing platform 602, and a data store 606. A FIPA messaging platform 608 carries raw data and facilitates internal and external communication among advocates, allowing them to “talk” to one another as variously described above in connection with FIGS. 1-5. A payload platform 610 moves facts and events (including policy, advocate, and relationship meta data changes) through the processing platform 604.

The perspective computing platform 602 includes a plurality of data processing silos, including: i) an advocate messaging services (event queue) module 612; ii) a content services (payload) module 614; iii) a relationship meta data services (social graphs/networked intelligence) module 616; iv) a value store services (attribute values) module 618; v) an awareness services (e.g., sensors) module 620; vi) a policy services (e.g., rules engine) module 622; and vii) an identity services (URIs, addresses) module 624. As facts and events are processed against rules and policies for the benefit of the advocates, the processed data transiently interacts with intermediary processing bins including: i) a data access module 626; ii) a provenance module 628; iii) an advocate management module 630; iv) an authentication and authorization module 632; and v) a messaging fabric module 634.

To facilitate the above-described processing, the perspective computing platform 602 accesses the following data stores, as needed: i) value store 636; ii) relationship meta data store 638; iii) provenance store 640; iv) configuration store 642; v) identity store 644; and vi) messaging store 646.

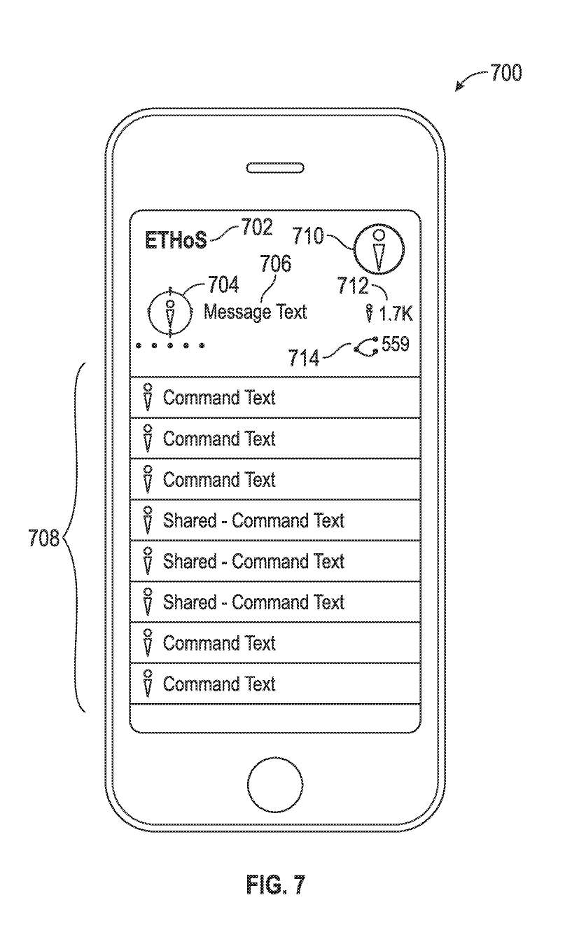

FIG. 7 is a schematic view of an exemplary graphical user interface (GUI) 700 for a client application running on a hand-held device. The GUI 700 includes a branding field 702, an advocate unread message indicator 704, an advocate message text field 706, an advocate command recipe menu 708, an advocate coupling, onboarding, and management control 710, a social graph utilization indicator 712, and one or more social metric fields 714.

More particularly, the branding field 702 permits original equipment manufacturers (OEMs) to private label the client application in any desired manner. The advocate unread message indicator 704 indicates the binary existence of and/or the number of currently unread messages or notifications the device has received from the advocate. The message text field 706 may be configured to display any desired message metric such as, for example, the subject, first few words, sender, source, or the like, and may be configured to horizontally or vertically swipe to reveal new messages.

With continued reference to FIG. 7, the advocate command recipe menu 708 may include user created and/or user shared commands, which may be configured local for storage at and processing by the cloud-based advocate ecosystem, discussed above. The commands may be configured to scroll vertically, and may display any desired number of commands, including a default number (e.g. in the range of 2-20, and preferably about 5 frequently used commands.

The social graph utilization indicator 712 may be configured to display any desired metric associated with private social graph usage such as percent of available memory, total number or range of numbers of facts and/or attributes, or the like. The social metric fields 714 may be configured to display any number of social metrics such as the number of machines (devices), humans, and/or other advocates are currently connected to the user's advocate.

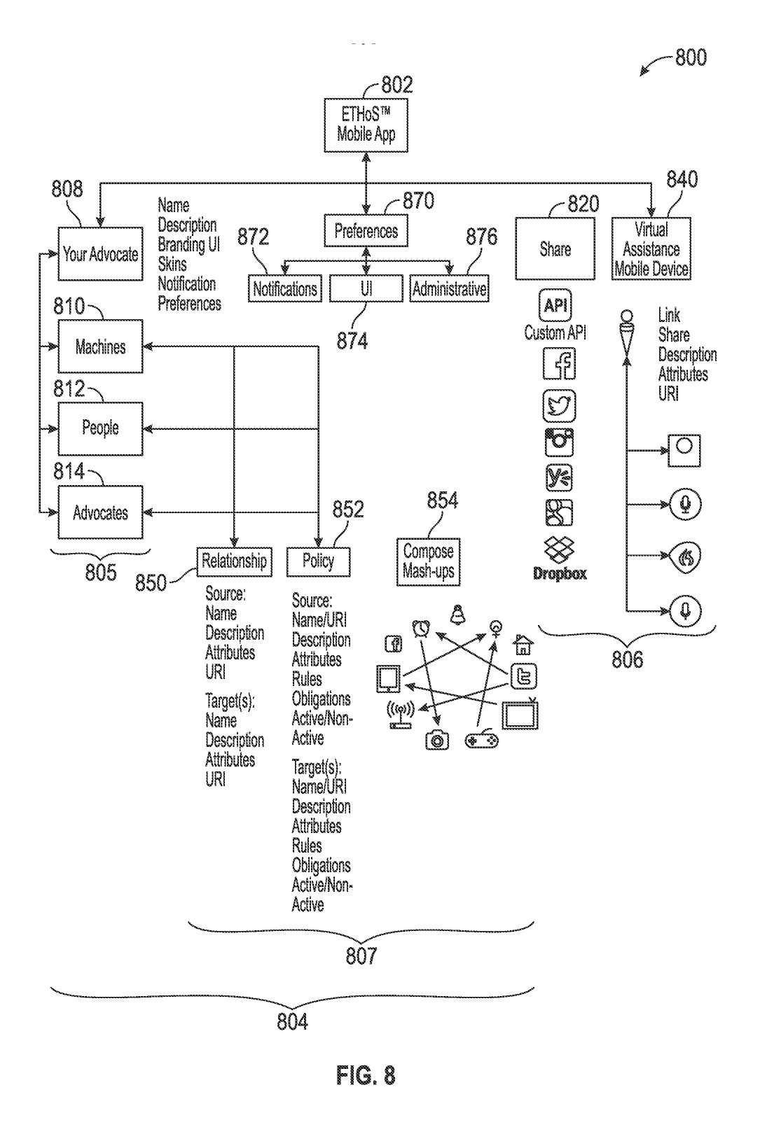

The advocate coupling, onboarding, and management control 710 may be used to instantiate the advocate associated with the client application, or otherwise manage the onboarding process, as described in greater detail in connection with FIG. 8 below.

Referring now to FIG. 8, a process flow diagram 800 for instantiating, onboarding, and otherwise managing an advocate will now be described. In particular, the diagram 800 includes a client application 802 for accessing core onboarding processes 804 and add-on boarding processes 806. The core onboarding processes 804 include relationship configuration modules 805 and policy configuration modules 807. The relationship configuration modules 805 include an advocate instantiation module 808, a machine relationship module 810, a people relationship module 812, and an advocate relationship module 814.

More particularly, depending on the context in which the client application is deployed, an advocate may be pre-instantiated with relationships, for example when a device (e.g., camera) manufacturer includes an ETHoS enabled API with the device. In such a case, the advocate will likely be pre-instantiated with a relationship to the device (more precisely, with the device's advocate in the cloud). The advocate associated with the client application may also be pre-instantiated with policies and/or permissions, such as when an employer requires an employee to consent to certain policies as a condition of employment.

The advocate instantiation module 808 facilitates the initial instantiation of the advocate associated with the client application, and coordinates the initialization of the advocate with respect to naming and branding the advocate, selecting GUI skins, and defining notification preferences (e.g., text, email, Apple alerts, and the like).

In various embodiments, advocates typically establish relationships with people (e.g., the employee's supervisor, a device manufacturer's customer service department, an IT officer, human resources department), machines (any device, process, machine, or thing addressable to the internet), and other advocates (recognizing that a human is typically behind every advocate). Accordingly, modules 810, 812, and 814 facilitate establishing initial and ongoing relationships between the native advocate and various machines, people, and other advocates. In this regard, although each human in the ecosystem typically has a unique advocate and vice versa, it is often helpful to be able to connect with a person, inasmuch as the identity of that person's advocate may not be visible.

Moreover, the advocate can connect directly to a device using the published security key if the device manufacturer provides a secure API. That is, the user can register the advocate into the device manufacturer's published API, and store the device URI in the advocate's social graph.

For each of the foregoing relationships, the policy configuration modules 807 allow the user to configure the policies and other metrics which control or otherwise influence each relationship. For example, a relationship module 850 defines names, descriptions, attributes, and URIs for each relationship. A policy module 852 defines any number of rules and policies (for example, in the form of IFTTT statements) for each relationship, and a mash-up module 854 allows the user to configure various mash-ups for the foregoing relationships. By way of non-limiting illustration, a mash-up may integrate an irrigation system and/or home security system with a smartphone to allow the user to remotely control the irrigation and security systems using the ETHoS interface, thereby bypassing the native APIs and streamlining the management of household systems.

Those skilled in the art will appreciate that the policy configuration modules 807 may also define privacy preferences, thereby determining the extent to which and under what circumstances personal data and information may be accessed by third parties.

The core onboarding processes 804 further include a preference configuration suite 870 including a notification module 872, a user interface (UI) module 874, and an administrative module 876. Specifically, the notification module 872 allows the user to define how notices from the advocate are to be received, e.g., as a banner, a slidable field, or as top level message text in the ETHoS client application. The user interface (UI) module 874 allows the user to configure skins, color schemes, shapes, and other visual and audio features. The administrative module 876 allows the user to configure security features.

With continued reference to FIG. 8, the add-on boarding processes 806 include sharing processes 820 and virtual assistance processes 840. More particularly, the sharing processes 820 involve linking the advocate to human social networks, so that the user may receive an alert when tagged with a picture on Facebook, or receive an alert when a Dropbox™ file is received. The virtual assistance processes 840 allow the user to leverage various virtual assistants as the “face” of the ETHoS client application, such as Cortana™, Nuance™, Siri™, and Google Talk™.

A social network platform is provided for sharing information between a first and a second advocate. The platform includes a knowledge database comprising a first and a second private social graph corresponding to the first and second advocates, respectively; a policy database comprising at least one rule governing the relationship between the first and second advocate; and an event server configured to process a first incoming event using the knowledge database and the policy database.

In an embodiment, the social network platform further comprises an agent server, wherein the first and second advocates each comprise a respective software machine configured to run on the agent server.

In an embodiment, the event server is configured to transmit an agent message to the agent server corresponding to the processed incoming event.

In an embodiment, the agent server is configured to process the agent message and transmit a second incoming event corresponding to the processed agent message to the event server.

In an embodiment, the agent server is configured to process the agent message using the knowledge database and the policy database.

In an embodiment, the knowledge database comprises a value store and a provenance store.

In an embodiment, the knowledge database comprises at least one data element in the form of a triplet including a subject, a predicate, and an object.

In an embodiment, the each of the subject, predicate, and object include a unique uniform resource identifier (URI).

In an embodiment, the value store comprises data values associated with corresponding data objects.

In an embodiment, the first event comprises a JSON string including a payload.

In an embodiment, the payload comprises an ID and a fact.

In an embodiment, the fact comprises a data triplet including a subject, a predicate and a verb.

In an embodiment, the social network platform further includes an event queue, wherein the event server is configured to transmit the agent message to the agent server via the event queue.

In an embodiment, the social network platform further includes an agent message queue, wherein the agent server is configured to transmit the second incoming event to the event server via the agent message queue.

In an embodiment, the event server is configured to access the knowledge database using a SPARQL query.

In an embodiment, the processing the first incoming event comprises using the ID to interrogate the knowledge database.

In an embodiment, processing the first incoming event further comprises analyzing the first incoming event against the at least one rule.

A networked intelligence database is also provided for use in a multi-advocate social network platform of the type which includes an event server configured to process event messages using rules governing interactions among a sub-set of the advocates. The networked intelligence database includes: a plurality of private social graphs, each corresponding to a respective one of the advocates and comprising a plurality of data elements, each data element comprising a subject, a predicate, and an object.

In an embodiment, the networked intelligence database is configured to store incremental changes in the data elements over time.

In an embodiment, each subject, predicate, and object comprise a unique addressable URI.

In an embodiment, the networked intelligence database includes a value store and a provenance store, wherein the value store comprises data values associated with corresponding data objects.

A client application is also provided for running on a host device on behalf of a first advocate, the client application configured to communicate with a cloud based platform of the type including an event server configured to process an event message against: i) a knowledge database comprising a private social graph associated with the first advocate; and ii) a policy database comprising at least one rule governing the behavior of the first advocate. The client application includes: a relationship module configured to establish relationships between the first advocate and other advocates within the private social graph; a policy module configured to define the at least one rule within the policy database; and a communication module for sending, in response to a trigger, an event message to the event server, the event message comprising a header identifying the host device and a payload comprising information about the trigger.

In an embodiment, the communication module is further configured to receive, from the platform, an action message resulting from the processed event message.

In an embodiment, the client application further includes a listening sensor for detecting the trigger.

An enterprise platform is also provided for facilitating interactions among a plurality of autonomous software advocates, each corresponding to a respective human owner, the platform comprising: a fact database; a rules database; and a processor configured to analyze incoming events against facts retrieved from the fact database and rules retrieved from the rules database.

In an embodiment, the fact database comprises an aggregate social graph including data elements configured by the human owners.

In an embodiment, the rules database comprises permissions configured by the human owners regarding use of the data elements.

In an embodiment, the permissions define human privacy preferences.

A cloud-based platform is also provided for simulating the socialization of a plurality of devices, each device having a unique software advocate, the platform comprising: a fact store including a plurality of private social graphs, each corresponding to a respective one of said advocates; an event server configured to process incoming events using networked intelligence derived from the fact store; an event queue configured to receive output messages from the event server; and an advocate server configured to receive messages broadcast from the event queue.

A method is also provided for forming an ad hoc social relationship between a first advocate on behalf of a first machine and a second advocate on behalf of a second machine. In an embodiment, the method includes: populating a first database with a first social graph associated with the first advocate, and a second social graph associated with the second advocate; populating a second database with a first rule governing the behavior of the first machine and a second rule governing the behavior of the second machine; and processing, by an event server, and event message using information obtained from the first social graph, the second social graph, the first rule, and the second rule.

In an embodiment, the method further includes: broadcasting an action message based on the processed event message; and receiving, by the first advocate, the action message; and sending a notification to the first machine based on the action message.

While there has been illustrated an enabling description of various embodiments including the best mode known to the inventor, it will be understood by those skilled in the art that various changes and modifications may be made and equivalents may be substituted for various elements without departing from the scope of the invention. Therefore, it is intended that the inventions disclosed herein not be limited to the particular embodiments disclosed, but that the invention will include all embodiments falling within the literal and equivalent scope of the appended claims.

1. A social network platform for sharing information between a first and a second advocate, comprising:
a knowledge database comprising a first and a second private social graph corresponding to the first and second advocates, respectively;
a policy database comprising at least one rule governing the relationship between the first and second advocate; and
an event server configured to process a first incoming event using the knowledge database and the policy database.

2. The social network platform of claim 1, further comprising an agent server, wherein the first and second advocates each comprise a respective software machine configured to run on the agent server.

3. The social network platform of claim 2, wherein the event server is configured to transmit an agent message to the agent server corresponding to the processed incoming event.

4. The social network platform of claim 3, wherein the agent server is configured to process the agent message and transmit a second incoming event corresponding to the processed agent message to the event server.

5. The social network platform of claim 4, wherein the agent server is configured to process the agent message using the knowledge database and the policy database.

6. The social network platform of claim 1, wherein the knowledge database comprises a value store and a provenance store.

7. The social network platform of claim 6, wherein the knowledge database comprises at least one data element in the form of a triplet including a subject, a predicate, and an object.

8. The social network platform of claim 7, wherein each of the subject, predicate, and object include a unique uniform resource identifier (URI).

9. The social network platform of claim 7, wherein the value store comprises data values associated with corresponding data objects.

10. The social network platform of claim 1, wherein the first incoming event comprises a JSON string including a payload.

11. The social network platform of claim 10, wherein the payload comprises an ID and a fact.

12. The social network platform of claim 11, wherein the fact comprises a data triplet including a subject, a predicate and a verb.

13. The social network platform of claim 4, further comprising an event queue, wherein the event server is configured to transmit the agent message to the agent server via the event queue.

14. The social network platform of claim 4, further comprising an agent message queue, wherein the agent server is configured to transmit the second incoming event to the event server via the agent message queue.

15. The social network platform of claim 1, wherein the event server is configured to access the knowledge database using a SPARQL query.

16. The social network platform of claim 11, wherein processing the first incoming event comprises using the ID to interrogate the knowledge database.

17. The social network platform of claim 16, wherein processing the first incoming event further comprises analyzing the first incoming event against the at least one rule.

18. (canceled)

19. (canceled)

20. (canceled)

21. A social network platform for sharing information among a plurality of advocates, comprising:
a knowledge database comprising a plurality of private social graphs, each corresponding to a respective one of the advocates;
a policy database comprising a plurality of rules governing relationships among the advocates; and
an event server configured to process an internal event and an external event using the knowledge database and the policy database.

22. The social network platform of claim 21, wherein the internal event corresponds to a message between advocates, and the external event corresponds to a message from an external sensor to an advocate.

23. The social network platform of claim 22, wherein the external event is configured for transmission to the social network platform from an application programming interface (API) associated with the sensor.
